(19) United States
(12) Patent Application Publication
(10) Pub. No.: US 2012/0037721 A1
(43) Pub. Date: Feb. 16, 2012

(54) PRESSURE WASHER HOSE CONVERTER FITTING

(76) Inventor: John D. Hall, Newhall, CA (US)

(21) Appl. No.: 12/857,209

(22) Filed: Aug. 16, 2010

(51) Int. Cl. B05B 9/00; F16L 33/00

(52) U.S. Cl. 239/124; 285/239

(57) ABSTRACT

In accordance with some embodiments, a pressure washer hose converter fitting is provided. In some embodiments, the pressure washer hose converter comprises: a threaded receiving end having internal threads for receiving a threaded outlet of a pressure washer, wherein the threaded outlet has a first diameter; a sealing gasket for engaging the threaded outlet of the pressure washer with the threaded receiving end; a threaded accepting end having external threads for accepting a threaded connector portion of a pressure washer hose of a second diameter; and a fluid transporting pathway connecting the threaded receiving end and the threaded accepting end; wherein the first diameter of the threaded outlet of the pressure washer is greater in diameter than the second diameter of the pressure washer hose; and wherein the threaded outlet of the pressure washer, the internal threads of the threaded receiving end, external threads of the threaded accepting end, and the threaded portion of the pressure washer hose have the same thread pitch.

### TECHNICAL FIELD

The disclosed subject matter relates to a pressure washer hose converter fitting. More particularly, the disclosed subject matter relates to a converter for connecting a pressure washer with a pump outlet having a particular diameter to a pressure washer hose having a different diameter than the diameter of the pump outlet, where the diameter of the pump outlet is greater than the diameter of the pressure washer hose.

### BACKGROUND

Generally speaking, pressure washers are used for cleaning and/or removing various materials (e.g., dirt, mold, grime, etc.) from surfaces, such as those on buildings and vehicles. These pressure washers typically include a pump that generates a high pressure stream of fluid through an outlet. A hose, which may be connected to a trigger gun, a wand, a spray nozzle, or any other suitable fluid delivery mechanism, is connected to the pressure washer at the outlet to transport the high pressure stream onto a surface.

After a given amount of time or after being subjected to harsh environmental conditions, the hose attached to the pressure washer may become damaged or weakened and may require replacement. One approach for replacing the hose is to purchase the respective hose that matches the outlet of the pressure washer. For example, if a pressure washer has an outlet with a diameter of 15 millimeters, the operator of the pressure washer purchases a hose that also has a diameter of 15 millimeters. This may be difficult as it requires manufacturers and retailers to provide pressure washer hoses of varying dimensions.

Another approach is to purchase a particular hose that accepts different sized outlets with the use of an integrated stepped connector on the end of the hose. This is sometimes referred to as a universal hose. The stepped connector portion of this hose has, within one end of the hose, two diameter openings with two o-rings—i.e., one o-ring for each particular diameter. That is, the first step of the stepped plug is the smallest diameter and each additional step increases in diameter. When connecting the hose having the integrated stepped connector with an outlet, the outlet continues to penetrate the connector until mating with the particular diameter opening that matches the diameter of the outlet. However, this can be expensive and difficult to maintain. First, when the hose portion of the hose with the integrated stepped connector requires replacing, the entire hose including the connector requires replacement. Second, standard hoses for pressure washers (i.e., hoses having a diameter of 14 millimeters) may be readily available, while the particular hose with the stepped connector may not be available at a retailer. Lastly, an operator of a pressure washer may desire different lengths of hose for performing particular tasks and, accordingly, would be required to purchase multiple hoses, each with the integrated stepped connector.

There is a need in the art for an approach that allows standard hoses for pressure washers to be used with pressure washers having outlets of different diameter. Accordingly, it is desirable to provide a pressure washer hose converter fitting that overcomes these and other deficiencies of the prior art.

### SUMMARY

The details of one or more embodiments of the subject matter described herein are set forth in the accompanying drawings and the description below. Other features and advantages of the subject matter described herein will be apparent from the description and drawings, and from the claims.

In accordance with some embodiments, a pressure washer hose converter fitting is provided. With the pressure washer hose converter fitting, a pressure washer with a pump outlet having a first diameter can be connected to a pressure washer hose having a second diameter, where the first diameter is greater in diameter than the second diameter. In a more particular example, a standard pressure washer hose having a diameter of 14 millimeters can be connected to a pressure washer having an outlet with a diameter of 15 millimeters with the use of the pressure washer hose converter fitting.

The pressure washer hose converter comprises: a threaded receiving end having internal threads for receiving a threaded outlet of a pressure washer, wherein the threaded outlet has a first diameter; a sealing gasket for engaging the threaded outlet of the pressure washer with the threaded receiving end; a threaded accepting end having external threads for accepting a threaded connector portion of a pressure washer hose of a second diameter; and a fluid transporting pathway connecting the threaded receiving end and the threaded accepting end; wherein the first diameter of the threaded outlet of the pressure washer is greater in diameter than the second diameter of the pressure washer hose; and wherein the threaded outlet of the pressure washer, the internal threads of the threaded receiving end, external threads of the threaded accepting end, and the threaded portion of the pressure washer hose have the same thread pitch.

In some embodiments, the first diameter of the threaded outlet of the pressure washer is about 15 millimeters and the second diameter of the pressure washer hose is about 14 millimeters.

In some embodiments, the pressure washer hose is a standard pressure washer hose and the pressure washer hose converter provides the fluid transporting pathway from the pressure washer having the threaded outlet of the first diameter to the standard pressure washer hose of the second diameter.

In some embodiments, upon receiving the threaded outlet in the threaded receiving end, the threaded outlet, the threaded receiving end, and the gasket form a sealed path for transporting fluid from the pressure washer.

In some embodiments, the gasket is configured near an opening of the threaded receiving end.

### BRIEF DESCRIPTION OF THE DRAWINGS

FIG. 1 is a diagram showing a cross-sectional view of an illustrative pressure washer hose converter fitting in accordance with some embodiments of the disclosed subject matter.

FIG. 2 is a diagram showing an illustrative pressure washer hose converter fitting connected to a pressure washer in accordance with some embodiments of the disclosed subject matter.

### DETAILED DESCRIPTION

In accordance with some embodiments, a pressure washer hose converter fitting is provided. With the pressure washer hose converter fitting, a pressure washer with a pump outlet having a first diameter can be connected to a pressure washer hose having a second diameter, where the first diameter is greater in diameter than the second diameter. In a more particular example, a standard pressure washer hose having a diameter of about 14 millimeters can be connected to a pressure washer having an outlet with a diameter of about 15 millimeters with the use of the pressure washer hose converter fitting.

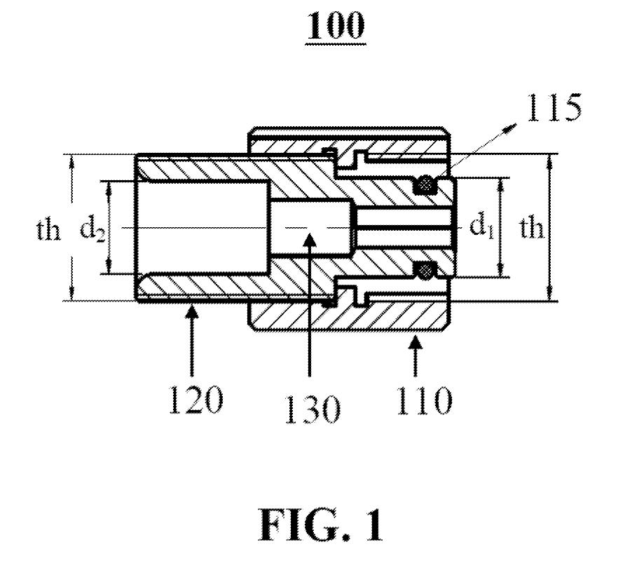

Turning to FIG. 1, a cross-sectional view of an illustrative pressure washer hose converter fitting 100 is shown in accordance with some embodiments of the disclosed subject matter. As shown, pressure washer hose converter fitting 100 has two ends—i.e., a threaded receiving end 110 and a threaded accepting end 120. The threaded receiving end 110 and the threaded accepting end 120 are connected by a fluid transporting pathway 130.

Pressure washer hose converter fitting 100, including threaded receiving end 110, threaded accepting end 120, and fluid transporting pathway 130, can be made of any suitable rigid, non-corrosive, durable material, such as a metal or any other suitable alloy (e.g., brass). In addition, pressure washer hose converter fitting 100 is able to withstand the normal stresses during operation of the pressure washer.

In some embodiments, threaded receiving end 110 has internal threads and has an opening with a diameter (d₁) capable of receiving a threaded outlet of a pressure washer. The threaded outlet of a pressure washer has a particular diameter. For example, some pressure washers have an outlet with a diameter of about 15 millimeters. Accordingly, threaded receiving end 110 is configured with a diameter (e.g., d₁=15 millimeters) to receive the threaded outlet of the pressure washer.

It should be noted that threaded receiving end 110 has internal threads for receiving the external threads on the outlet of a pressure washer. Upon connecting threaded receiving end 110 to the threaded outlet of the pressure washer, a sealed path or channel is formed for transporting fluid from the outlet of the pressure washer through a fluid transporting pathway 130. More particularly, a pump mechanism of the pressure washer pulls a fluid (e.g., water) from one or more tanks and generates a high pressure fluid that flows through the outlet of the pressure washer and into fluid transporting pathway 130.

In some embodiments, a sealing gasket 115, such as an o-ring, can be used for engaging the threaded outlet of the pressure washer with threaded receiving end 110. As shown in FIG. 1, sealing gasket 115 can be configured to be near the opening of threaded receiving end 110.

It should be noted that the thread pitch for threaded receiving end 110 and the thread for the outlet is the same. In a more particular embodiment, threaded receiving end 110 of pressure washer hose converter fitting 100, the threaded outlet of the pressure washer, and any other threaded portion have the same form, pitch thread, and taper. For example, as shown in FIG. 1, thread (th) can preferably conform to ISO metric thread M22×1.5 millimeters. As also shown in FIG. 1, other threaded portions of pressure washer hose converter fitting 100 (e.g., threaded accepting end 120) have the same thread (th).

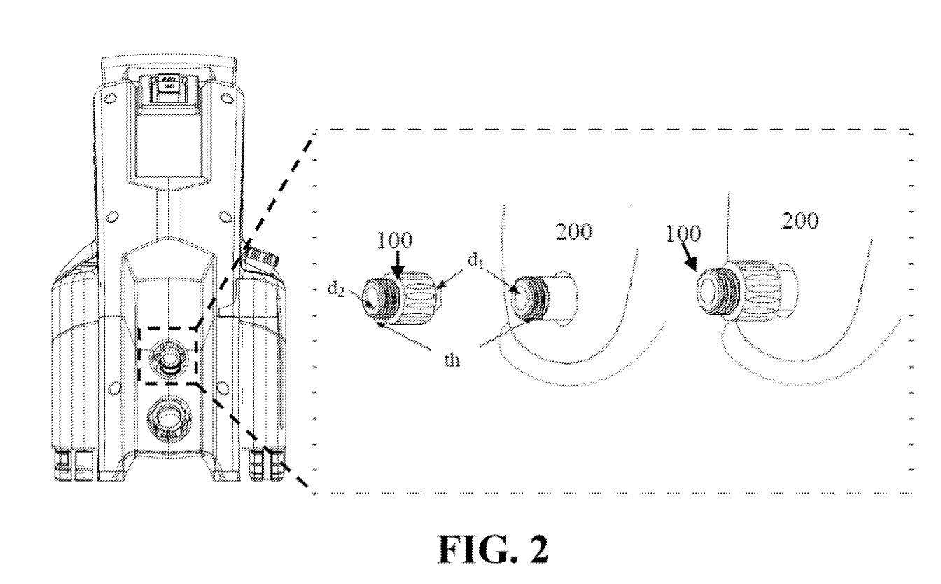

As shown in FIG. 2, a pressure washer 200 having an outlet with an outlet diameter (d₁) is provided. Pressure washer hose converter fitting 100 is attached to pressure washer 200, where threaded receiving end 110 of pressure washer hose converter fitting 110 has the same diameter (d₁) as the outlet of pressure washer 200. Pressure washer hose converter fitting 100 extends from pressure washer 200 to allow a standard hose or a hose of a particular diameter (e.g., a hose with a diameter of 14 millimeters) to be attached to pressure washer 200.

Referring back to FIG. 1, pressure washer hose converter fitting 110 includes a threaded accepting end 120 for accepting a threaded connector portion of a pressure washer hose. Threaded accepting end 120 has a particular diameter (d₂) that matches the diameter of the pressure washer hose. For example, a standard pressure washer hose having a diameter of about 14 millimeters can be attached to threaded accepting end 120, where diameter (d₂) is about 14 millimeters.

Threaded accepting end 120 has external threads for accepting a hose with a connector having internal threads. It should be noted that, similar to threaded receiving end 110 and the thread of the outlet of the pressure washer, threaded accepting end 120 and the threaded connector of the pressure washer hose have the same thread (th).

In some embodiments, the diameter (d₁) of threaded receiving end 110 is greater in diameter than the diameter (d₂) of threaded accepting end 120. For example, the diameter (d₁) of threaded receiving end 110 is about 15 millimeters and the diameter (d₂) of threaded accepting end 120 is about 14 millimeters.

Accordingly, a pressure washer hose converter fitting is provided.

Although the invention has been described and illustrated in the foregoing illustrative embodiments, it is understood that the present disclosure has been made only by way of example, and that numerous changes in the details of implementation of the invention can be made without departing from the spirit and scope of the invention. Features of the disclosed embodiments can be combined and rearranged in various ways.

What is claimed is:

1. A pressure washer hose converter comprising:
a threaded receiving end having internal threads for receiving a threaded outlet of a pressure washer, wherein the threaded outlet has a first diameter;
a sealing gasket for engaging the threaded outlet of the pressure washer with the threaded receiving end;
a threaded accepting end having external threads for accepting a threaded connector portion of a pressure washer hose of a second diameter; and
a fluid transporting pathway connecting the threaded receiving end and the threaded accepting end;
wherein the first diameter of the threaded outlet of the pressure washer is greater in diameter than the second diameter of the pressure washer hose; and
wherein the threaded outlet of the pressure washer, the internal threads of the threaded receiving end, external threads of the threaded accepting end, and the threaded portion of the pressure washer hose have the same thread pitch.

2. The pressure washer hose converter of claim 1, wherein the first diameter of the threaded outlet of the pressure washer is about 15 millimeters and the second diameter of the pressure washer hose is about 14 millimeters.

3. The pressure washer hose converter of claim 1, wherein the pressure washer hose is a standard pressure washer hose and the pressure washer hose converter provides the fluid transporting pathway from the pressure washer having the threaded outlet of the first diameter to the standard pressure washer hose of the second diameter.

4. The pressure washer hose converter of claim 1, wherein, upon receiving the threaded outlet in the threaded receiving end, the threaded outlet, the threaded receiving end, and the gasket form a sealed path for transporting fluid from the pressure washer.

5. The pressure washer hose converter of claim 1, wherein the gasket is configured near an opening of the threaded receiving end.

6. A pressure washer apparatus comprising:
a pressure washer component for generating high pressure liquid from a threaded outlet, wherein the threaded outlet of the pressure washer component is configured to receive a pressure washer hose; and
a pressure washer converter that attaches to the threaded outlet of the pressure washer component, the pressure washer converter includes:
a threaded receiving end having internal threads for receiving the threaded outlet of the pressure washer component, wherein the threaded outlet has a first diameter;
a sealing gasket for engaging the threaded outlet of the pressure washer component with the threaded receiving end;
a threaded accepting end having external threads for accepting a threaded connector portion of the pressure washer hose of a second diameter; and
a fluid transporting pathway connecting the threaded receiving end and the threaded accepting end;
wherein the first diameter of the threaded outlet of the pressure washer component is greater in diameter than the second diameter of the pressure washer hose; and
wherein the threaded outlet of the pressure washer component, the internal threads of the threaded receiving end, external threads of the threaded accepting end, and the threaded portion of the pressure washer hose have the same thread pitch.
